(19) United States
(12) Patent Application Publication
(10) Pub. No.: US 2026/0050060 A1
(43) Pub. Date: Feb. 19, 2026

(54) ILLUMINATED RADAR MODULE

(71) Applicant: ams-OSRAM International GmbH, Regensburg (DE)

(72) Inventors: Erwin LANG, Regensburg (DE); Christian SCHOERNER, Regensburg (DE); Farhang GHASEMI AFSHAR, Wenzenbach (DE); Georg ROSSBACH, Wenzenbach (DE)

(21) Appl. No.: 19/119,947

(22) PCT Filed: Sep. 20, 2023
(86) PCT No.: PCT/EP2023/075919

§ 371 Date: Apr. 10, 2025

(30) Foreign Application Priority Data
Oct. 12, 2022 (DE) 10 2022 126 446.7

(51) Int. Cl. G01S 7/02; B60R 11/02

(52) U.S. Cl. CPC G01S 7/025; B60R 11/0235; G01S 7/023; G01S 7/027

(57) ABSTRACT

An illuminated radar module includes an emitter emitting a linearly polarized first electromagnetic radiation during operation. The illuminated radar module also includes a display device including a plurality of light-emitting elements and conductor tracks for electrically contacting the light-emitting elements. The display device is arranged downstream of the emitter in an emission direction of the first electromagnetic radiation. In a radiation region of the first electromagnetic radiation the conductor tracks extend over at least 70% of their length transversely to the polarization direction of the first electromagnetic radiation. The display device includes a carrier which is at least partially transparent to the first electromagnetic radiation. The light-emitting elements and the conductor tracks are arranged on the carrier. The plurality of light-emitting elements are arranged on the carrier in the form of a symbol.

An illuminated radar module is specified.

Radar modules are used in vehicles, for example, to determine the distance to an external object. For example, for aesthetic reasons, the arrangement of an illuminated cover, such as an electroluminescent symbol or logo, on or in front of an emitter of the radar module may be desirable. However, electrically conductive elements in the illuminated cover of such an illuminated radar module may lead to absorption of the radar radiation emitted by the emitter and thus to a reduction of a signal-to-noise ratio of the radar module.

One object of at least certain embodiments is to provide an illuminated radar module comprising an improved signal-to-noise ratio.

According to at least one embodiment, the illuminated radar module comprises an emitter emitting a linearly polarized first electromagnetic radiation during operation. In particular, the emitter is configured for generating first electromagnetic radiation with a wavelength in a microwave range. For example, the emitter comprises a semiconductor component in which an oscillator for generating the first electromagnetic radiation and an antenna for a directional emission of the first electromagnetic radiation are integrated.

In particular, the linearly polarized first electromagnetic radiation comprises a polarization direction that does not change during operation of the illuminated radar module. A degree of polarization of the linearly polarized first electromagnetic radiation is, for example, at least 70%, preferably at least 90%, particularly preferably at least 99%. In other words, a fraction of at least 70%, preferably at least 90%, and particularly preferably at least 99%, of the first electromagnetic radiation is linearly polarized along the polarization direction, while the remaining proportion can have a polarization perpendicular thereto.

According to at least one further embodiment, the illuminated radar module comprises a display device comprising a plurality of light-emitting elements and conductor tracks for electrically contacting the light-emitting elements. In particular, the display device comprises a main extension plane, which is preferably arranged perpendicular to an emission direction of the first electromagnetic radiation. The main extension plane of the display device can be arranged inclined relative to the emission direction.

The light-emitting elements are arranged, for example, in the main extension plane of the display device. The light-emitting elements preferably emit light in the visible spectral range during operation. The display device is configured, for example, for displaying information in the form of an image, a sequence of images or a symbol.

In particular, the conductor tracks are configured for conducting an electrical operating current to the plurality of light-emitting elements during operation of the illuminated radar module. For example, the conductor tracks comprise a metal or consist of a metal.

According to at least one further embodiment of the illuminated radar module, the display device is arranged downstream of the emitter in an emission direction of the first electromagnetic radiation. In other words, the first electromagnetic radiation generated by the emitter during operation penetrates the display device at least partially before it is coupled out of the illuminated radar module. The display device is at least partially transparent to the first electromagnetic radiation generated by the emitter during operation. For example, a transmittance of the display device for the first electromagnetic radiation emitted by the emitter is at least 30%, preferably at least 70%, particularly preferably at least 90%.

According to at least one further embodiment of the illuminated radar module, in a radiation region of the first electromagnetic radiation the conductor tracks extend over at least 70% of their length, preferably over at least 90% of their length, transversely to the polarization direction of the first electromagnetic radiation. Here and in the following, the radiation region refers to a region of the display device that is penetrated by the first electromagnetic radiation during operation of the illuminated radar module. For example, a linear extension of the radiation region corresponds to a beam width of the first electromagnetic radiation on a surface of the display device. In particular, the beam width denotes a width of an intensity distribution of the first electromagnetic radiation perpendicular to the emission direction, at which the intensity is 13% of a maximum intensity. The linear extension of the radiation region is, for example, at least five times, preferably at least ten times, the wavelength of the first electromagnetic radiation.

The features of a conductor track described in the following apply in particular to a majority of the conductor tracks, preferably to all conductor tracks. Here and in the following, the length of the conductor track refers to a linear extension of the conductor track in the direction of a current flow of the electrical operating current along the conductor track. The conductor track can be straight, curved or of any shape. In particular, the conductor track may comprise several sections that run in a straight line, for example, and extend in different directions. The different sections of a conductor track are electrically connected to each other. The length of the conductor track refers, in particular, to the sum of the partial lengths of all sections of the conductor track.

For example, the conductor tracks in a radiation region of the first electromagnetic radiation extend over at least 70%, preferably at least 90%, of their total length transverse to the polarization direction of the first electromagnetic radiation. In particular, the total length refers to the sum of the lengths of all conductor tracks in the radiation region of the first electromagnetic radiation.

Here and in the following, “transverse” means either perpendicular or deviating from perpendicular by at most ±30°, preferably by at most ±10° and particularly preferably by at most ±5°. In other words, conductor tracks running transverse to the polarization direction are, in particular, conductor tracks running perpendicular to the polarization direction, or conductor tracks whose course deviates from a direction perpendicular to the polarization direction by at most ±30°, preferably by at most ±10° and particularly preferably by at most ±5°. For example, the transmittance of the display device is reduced by approximately 14% for a deviation of ±30°, by approximately 2% for a deviation of ±10°, and by less than 1% for a deviation of ±5°.

Furthermore, here and in the following the directions of conductor tracks can deviate from the specified direction, in particular within the scope of manufacturing tolerances. For example, the direction of a conductor track that runs perpendicular or parallel to the polarization direction of the first electromagnetic radiation may deviate by ±5° from the specified direction.

According to a preferred embodiment, the illuminated radar module comprises:
an emitter emitting a linearly polarized first electromagnetic radiation during operation,
a display device comprising a plurality of light-emitting elements and conductor tracks for electrically contacting the light-emitting elements, wherein
the display device is arranged downstream of the emitter in an emission direction of the first electromagnetic radiation, and
in a radiation region of the first electromagnetic radiation the conductor tracks extend over at least 70% of their length transversely to the polarization direction of the first electromagnetic radiation.

According to at least one further embodiment of the illuminated radar module, in the radiation region of the first electromagnetic radiation a length of each conductor track projected onto the polarization direction of the first electromagnetic radiation is at most five times, preferably at most twice, and particularly preferably at most one times the wavelength of the first electromagnetic radiation. In particular, sections of the conductor tracks which run parallel to the polarization direction are advantageously smaller than the wavelength of the first electromagnetic radiation, preferably smaller than half the wavelength of the first electromagnetic radiation, and particularly preferably smaller than one tenth of the wavelength of the first electromagnetic radiation, in order to reduce an absorption of the first electromagnetic radiation by the conductor tracks.

Here and in the following the projected length refers to a portion of the length of the conductor track that is parallel to the direction onto which the conductor track is projected. In particular, the projected length of a straight conductor track corresponds to the actual length of the conductor track multiplied by the cosine of the included angle between the conductor track and the direction onto which the conductor track is projected. For arbitrarily shaped conductor tracks, the projected length can be calculated by dividing the conductor track into a large number of approximately straight sections and summing the projected lengths of all sections.

According to a further preferred embodiment, the illuminated radar module comprises:
an emitter emitting a linearly polarized first electromagnetic radiation during operation,
a display device comprising a plurality of light-emitting elements and conductor tracks for electrically contacting the light-emitting elements, wherein
the display device is arranged downstream of the emitter in an emission direction of the first electromagnetic radiation, and
in the radiation region of the first electromagnetic radiation a length of each conductor track projected onto the polarization direction of the first electromagnetic radiation is at most five times a wavelength of the first electromagnetic radiation.

In particular, the illuminated radar module described herein is based on the idea of arranging the conductor tracks of the display device in such a way that the display device is as transparent as possible for the first electromagnetic radiation generated by the emitter during operation.

Electrically conductive elements of the display device, such as the conductor tracks, can have a high degree of absorption and/or a high degree of reflection for the first electromagnetic radiation. As a result, for example, the first electromagnetic radiation coupled out by the illuminated radar module can be greatly attenuated as it passes through the display device. Furthermore, the first electromagnetic radiation reflected back from an external object, which is to be detected by the illuminated radar module, for example, can also be greatly attenuated as it passes through the display device before it is incident on a detector. Thus, for example, a signal-to-noise ratio of the illuminated radar module is reduced by the display device in front of the emitter and/or the detector.

By arranging the conductor tracks of the display device in a direction transverse or perpendicular to the polarization direction of the first electromagnetic radiation, in particular the absorption coefficient and/or the reflection coefficient of the display device for the first electromagnetic radiation generated by the emitter during operation is greatly reduced and the transmittance of the display device is advantageously increased accordingly. Thus, the arrangement of the display device in the emission direction in front of the emitter advantageously leads to only a small or insignificant reduction in the signal-to-noise ratio of the illuminated radar module.

The illuminated radar module described herein thus enables, in particular, the arrangement of an illuminated cover on the emitter and/or the detector. For example, the illuminated radar module can be used for distance measurement in vehicles. In this case, the display device can, for example, display an illuminated logo, while the emitter and/or the detector for distance measurement are arranged behind the illuminated logo. In particular, the display device can also be suitable for displaying a moving or animated image, for example as a sequence of at least two individual images.

According to at least one further embodiment of the illuminated radar module, the first electromagnetic radiation comprises a wavelength in a range between 1 mm and 10 cm, inclusive.

According to at least one further embodiment of the illuminated radar module, at least one light-emitting element emits a second electromagnetic radiation during operation, which comprises the same emission direction as the first electromagnetic radiation. In particular, the second electromagnetic radiation comprises wavelengths in a visible spectral range. Preferably, a majority of the light-emitting elements, particularly preferably all light-emitting elements, comprise the same emission direction as the first electromagnetic radiation.

According to at least one further embodiment of the illuminated radar module, at least one light-emitting element comprises a light-emitting semiconductor diode (in short: LED) with an edge length of at most 1 mm, preferably of at most 300 μm, particularly preferably of at most 70 μm. The light-emitting semiconductor diode comprises, in particular, an epitaxial semiconductor layer stack with a pn junction, which is configured for converting the electrical operating current into the second electromagnetic radiation. Preferably, each light-emitting element is formed as a light-emitting semiconductor diode.

For example, each light-emitting element is a mini-LED or a micro-LED. In particular, mini-LEDs have an edge length of at most 300 μm, while micro-LEDs have an edge length of at most 70 μm, for example. In particular, the edge length refers to a linear extension of the light-emitting semiconductor diode in a direction perpendicular to the emission direction of the second electromagnetic radiation. In particular, by using particularly small light-emitting semiconductor diodes, the degree of absorption of the display device for the first electromagnetic radiation is reduced. Preferably, the edge length of the light-emitting semiconductor diode is at most the wavelength, preferably at most one tenth of the wavelength of the first electromagnetic radiation.

The micro LED is a light emitting diode (abbreviated as “LED”) that comprises a particularly small size. In particular, the micro LED is not a laser.

In the case of the micro-LED, for example, a growth substrate on which a semiconductor layer sequence of the micro-LED has been epitaxially grown has been removed. In other words, the micro LED does not comprise a growth substrate. Furthermore, the micro-LED in particular does not comprise a stabilizing carrier as an alternative to the growth substrate. A thickness or height of the micro-LED in the growth direction of the semiconductor layer sequence is, for example, between 1.5 μm and 10 μm inclusive.

The micro-LED comprises, for example, a rectangular or otherwise shaped radiation emitting surface. In plan view of the layers of the semiconductor layer sequence, each lateral extension of the radiation emission surface is, for example, at most 100 μm or at most 70 μm.

For example, the edge length of rectangular micro-LEDs—especially when viewed from above on the layers of the semiconductor layer sequence—is at most 70 μm or at most 50 μm. Micro-LEDs are provided, for example, on wafers with non-destructively detachable holding structures for the μLED. Micro-LEDs are also referred to as μLEDs, μ-LEDs, uLEDs, u-LEDs or Micro Light Emitting Diodes, for example.

For example, displays are considered as applications for micro-LEDs. Herein, the micro-LEDs form pixels or sub-pixels and emit light of a defined color. Due to the small pixel size and high density with a short distance, micro LEDs are suitable for small monolithic displays for AR applications, in particular data glasses. Work is also underway on other applications, particularly in data communication or pixelated lighting applications.

For example, a distance between adjacent light-emitting elements of the display device is between 100 μm and 200 μm, inclusive. This reduces, for example, the degree of absorption of the display device for the first electromagnetic radiation, while the light-emitting elements generate a luminance distribution that is as homogeneous as possible. Furthermore, this means, in particular, that no gaps between the light-emitting elements can be recognized by an external observer.

According to at least one further embodiment of the illuminated radar module, a width of the conductor tracks is at most 1 mm, preferably at most 100 μm, and particularly preferably at most 50 μm. Here and in the following, the width of the conductor track denotes a linear extension of the conductor track in a direction perpendicular to the direction of current flow of the electrical operating current, as well as perpendicular to the main plane of extension of the display device. For example, a width of the conductor track is at most one tenth, preferably at most one twentieth, of the wavelength of the first electromagnetic radiation. This can advantageously reduce the degree of absorption and/or the degree of reflection of the conductor track for the first electromagnetic radiation.

According to at least one further embodiment of the illuminated radar module, a distance between sections of the conductor tracks extending perpendicular to the polarization direction of the first electromagnetic radiation in the radiation region of the first electromagnetic radiation is at least 100 μm. For example, the distance between sections of the conductor tracks extending perpendicular to the polarization direction is between 100 μm and 5 mm, inclusive, for example the distance is 200 μm. In particular, the distance between sections of the conductor tracks extending perpendicular to the polarization direction is at least one tenth of the wavelength of the first electromagnetic radiation. In particular, the distance refers to a linear distance between facing edges of adjacent conductor tracks. In particular, the distance between sections of the conductor tracks that run perpendicular to the polarization direction is equal to or greater than the width of a conductor track. This advantageously reduces the absorption of the first electromagnetic radiation by the conductor tracks.

According to at least one further embodiment of the illuminated radar module, sections of the conductor tracks in the radiation region of the first electromagnetic radiation, which extend in a direction parallel to the polarization direction of the first electromagnetic radiation, have a length of at most one tenth of the wavelength of the first electromagnetic radiation. Sections of the conductor tracks that run parallel to the polarization direction of the first electromagnetic radiation have, for example, a comparatively high degree of absorption and/or reflectance for the first electromagnetic radiation. By designing the conductor tracks with as few and/or as short sections parallel to the polarization direction as possible, the transmittance of the display device for the first electromagnetic radiation can thus be advantageously increased.

According to at least one further embodiment of the illuminated radar module, a distance between sections of the conductor tracks running parallel to the polarization direction of the first electromagnetic radiation in the radiation region of the first electromagnetic radiation is equal to or larger than half the wavelength of the first electromagnetic radiation. As a result, the transmittance of the display device for the first electromagnetic radiation can be advantageously increased.

According to at least one further embodiment of the illuminated radar module, sections of the conductor tracks in the radiation region of the first electromagnetic radiation, which have a main extension direction parallel to the polarization direction of the first electromagnetic radiation, are meander-shaped. Here and in the following, the main extension direction of the section of the conductor track denotes, for example, a direction of a connecting line between a starting point of the section and an end point of the section of the conductor track.

The meandering section of the conductor track comprises, for example, several sections arranged parallel to each other that run perpendicular to the polarization direction. End points of neighboring subsections are connected to each other, for example, via curved, in particular semicircular, conductor track sections. Due to the meandering shape, the section of the conductor track comprises only particularly short areas that run parallel to the polarization direction. This can advantageously increase the transmittance of the display device for the first electromagnetic radiation.

According to at least one further embodiment of the illuminated radar module, sections of the conductor tracks that run parallel to the polarization direction of the first electromagnetic radiation are arranged outside the radiation region of the first electromagnetic radiation. For example, all sections of the conductor tracks that run parallel to the polarization direction are arranged outside the radiation region. For example, the conductor tracks in the radiation region extend exclusively perpendicular to the polarization direction. This advantageously increases the transmittance of the display device for the first electromagnetic radiation.

According to at least one further embodiment of the illuminated radar module, at least one conductor track comprises at least two parallel segments that are electrically connected to one another in places. In other words, at least one conductor track comprises a plurality of through holes, which are arranged, in particular, along the main extension direction of the conductor track. The holes extend, for example, in a direction perpendicular to the main extension plane of the display device. For example, the conductor track comprises three parallel segments.

Preferably, each segment of the conductor track is configured for carrying the electrical operating current of the light-emitting elements connected to the segment alone. In other words, the at least two parallel segments are redundant. For example, each segment of the conductor track has a thickness of at most 15 μm. Here and in the following, the thickness denotes a spatial extension of the conductor track perpendicular to the main extension plane of the display device.

For example, very thin conductor tracks may comprise interruptions due to a manufacturing process. The use of redundant segments, for example, ensures the functionality of the display device if isolated interruptions occur in a segment of the conductor track. Furthermore, a particularly uniform and/or high transparency of the display device can be achieved by using particularly thin conductor tracks. In particular, a display device with particularly thin conductor tracks comprises a higher transmittance for the first electromagnetic radiation.

According to at least one further embodiment of the illuminated radar module, a plurality of light-emitting elements is electrically connected in series via a conductor track running perpendicular to the polarization direction of the first electromagnetic radiation. Therefore, for example, the number of conductor tracks required for the electrical connection of the plurality of light-emitting elements can be reduced. The display device thus advantageously has a higher transmittance for the first electromagnetic radiation.

The light-emitting elements of the display device can be divided into groups. In particular, the groups of light-emitting elements can be controlled individually. In other words, each group of the display device can be operated separately from one another. A group can comprise several light-emitting elements or only a single light-emitting element. The light-emitting elements of a group are, for example, electrically connected in series via a conductor track running perpendicular to the polarization direction of the first electromagnetic radiation. For example, a group of light-emitting elements forms a segment of the display device, which is electrically controlled via a channel of a driver circuit.

According to at least one further embodiment of the illuminated radar module, a plurality of light-emitting elements that are arranged next to one another in a direction perpendicular to the polarization direction of the first electromagnetic radiation are divided into two sub-strands that are electrically connected in parallel, wherein the light-emitting elements of each sub-strand are electrically connected in series.

For example, one channel of the driver circuit provides a maximum operating voltage via which only a limited number of light-emitting elements can be operated in series. By dividing the light-emitting elements, which are arranged in a line, into sub-strands connected in parallel, fewer channels of the driver circuit are advantageously required to operate the display device.

According to at least one further embodiment, the illuminated radar module comprises a detector for the first electromagnetic radiation. For example, the detector is arranged next to the emitter in a direction perpendicular to the emission direction of the first electromagnetic radiation. The detector is configured, for example, for detecting the first electromagnetic radiation that is emitted by the emitter and that is at least partially reflected by an external object. In particular, the emitter and the detector form a unit for the detection and ranging of external objects (radio detection and ranging, short: RADAR).

In particular, the first electromagnetic radiation is transmitted through the display device before being decoupled from the illuminated radar module. The first electromagnetic radiation that is at least partially reflected by the external object is in turn coupled into the illuminated radar module, where it is transmitted through the display device before being detected by the detector. For example, the illuminated radar module is configured for measuring a distance between the illuminated radar module and the external object.

According to at least one further embodiment of the illuminated radar module, the display device comprises a carrier which is at least partially transparent to the first electromagnetic radiation, wherein the light-emitting elements and the conductor tracks are arranged on the carrier. The main extension plane of the display device corresponds, in particular, to a main surface of the carrier. Preferably, the light-emitting elements and the conductor tracks are arranged on the main surface of the carrier.

For example, the carrier comprises a flexible film or is a flexible film. In particular, the carrier comprises an electrically insulating material. For example, the carrier comprises a plastic, in particular polyimide or polyethylene, or consists of one of these materials.

According to at least one further embodiment of the illuminated radar module, the plurality of light-emitting elements are arranged on the carrier in the form of a symbol.

Further advantageous embodiments and further developments of the illuminated radar module follow from the exemplary embodiments described below in connection with the figures.

FIG. 1 shows a schematic perspective view of an illuminated radar module according to an exemplary embodiment.

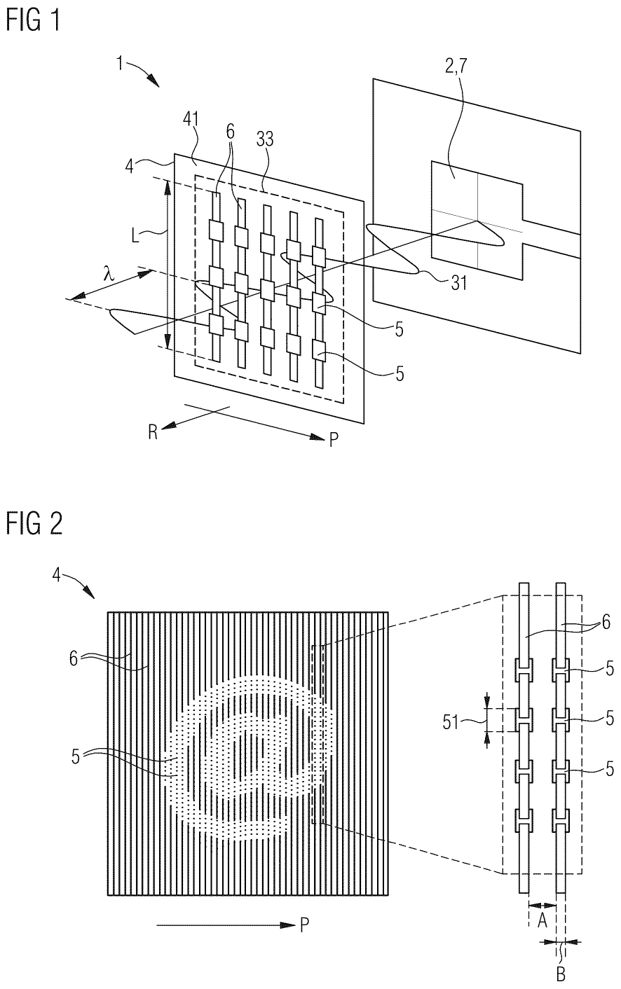

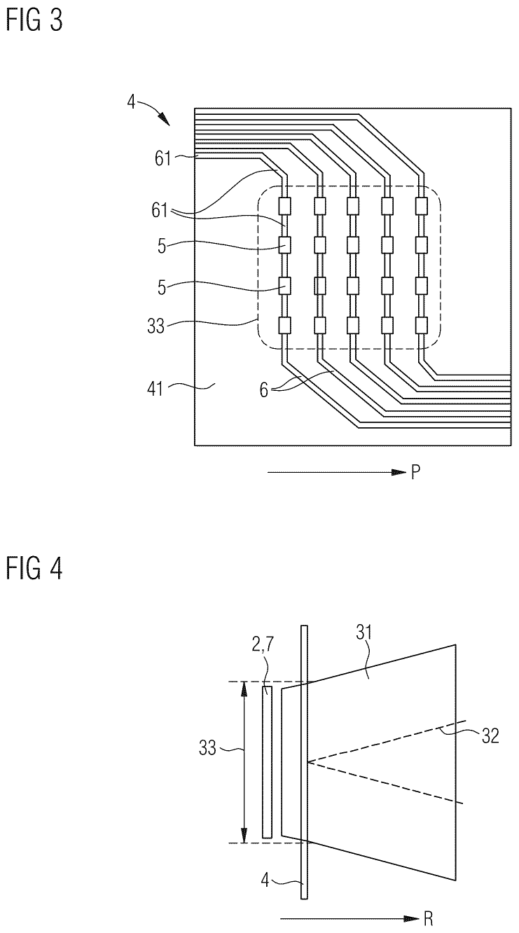

FIGS. 2 and 3 show schematic views of a display device of an illuminated radar module according to various exemplary embodiments.

FIG. 4 shows a schematic sectional view of an illuminated radar module according to an exemplary embodiment.

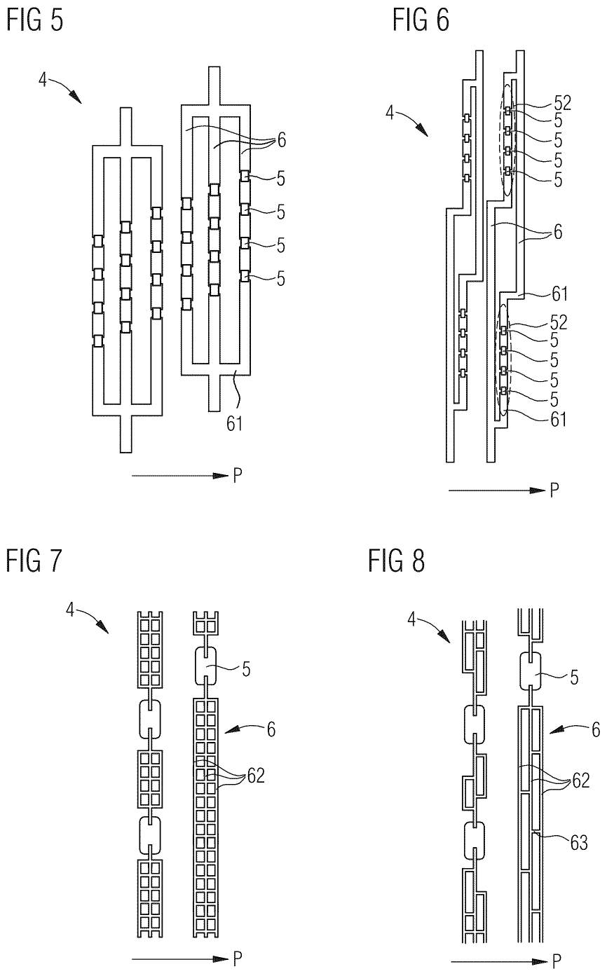

FIGS. 5 to 11 show schematic arrangements of conductor tracks and light-emitting elements of a display device of an illuminated radar module according to various exemplary embodiments.

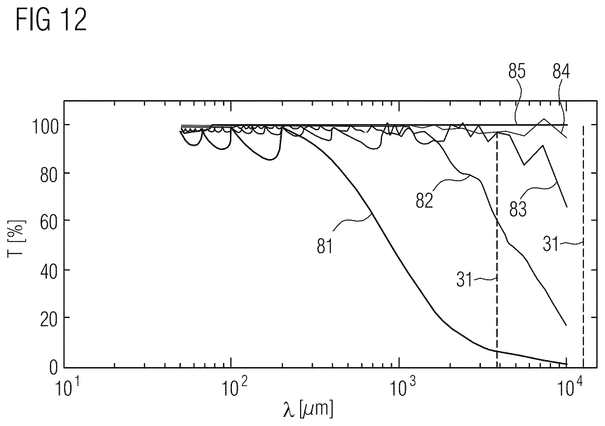

FIG. 12 shows a numerical simulation of a transmittance of a display device of an illuminated radar module according to a further exemplary embodiment.

Elements that are identical, similar or have the same effect are marked with the same reference symbols in the figures. The figures and the proportions of the elements shown in the figures should not be considered to be true to scale. Rather, individual elements may be shown exaggeratedly large for better visualization and/or understanding.

The exemplary embodiment of the illuminated radar module 1 in FIG. 1 comprises an emitter 2, a detector 7 and a display device 4. During operation, the emitter 2 emits a linearly polarized first electromagnetic radiation 31 with a wavelength λ in a range between one millimeter and ten centimeters. In particular, during operation, the emitter emits directional first electromagnetic radiation 31 in an angular range of, for example, ±75° or preferably ±20° around the emission direction R. The detector 7 is arranged next to the emitter 2 in a direction perpendicular to the emission direction R of the first electromagnetic radiation 31. In particular, the emitter 2 and the detector 7 are configured for detecting and determining the distance of an external object.

The display device 4 is arranged downstream of the emitter in the emission direction R of the first electromagnetic radiation 31. The display device 4 comprises a carrier 41 on which a plurality of light-emitting elements 5 are arranged, which are electrically contacted via metallic conductor tracks 6. The carrier 41 comprises a plastic film which is at least partially transparent to the first electromagnetic radiation 31.

During operation, the light-emitting elements 5 emit a second electromagnetic radiation 32 (not shown) in a visible spectral range. At least a part of the second electromagnetic radiation 32 is emitted parallel to the emission direction R of the first electromagnetic radiation 31. For example, the display device 4 is an illuminated cover of the emitter 2 and the detector 7, which is at least partially transparent to the first electromagnetic radiation 31.

The first electromagnetic radiation 31 penetrates the display device 4 within a radiation region 33. The linear extension of the radiation region 33 corresponds, in particular, to the beam width of the first electromagnetic radiation 31 on the main surface of the carrier 41. At least a part of the light-emitting elements 5 and at least parts of the conductor tracks 6 are arranged within the radiation region 33.

Within the radiation region 33, the conductor tracks 6 preferably run perpendicular to the polarization direction P of the first electromagnetic radiation 31. In this case, the conductor tracks 6 are arranged perpendicular to the polarization direction P over at least 70% of their length L in the radiation region 33. The length L denotes a spatial extension of a conductor track 6 in the current flow direction of the electrical operating current. This arrangement of the conductor tracks 6 advantageously increases the transmittance of the display element 4 for the first electromagnetic radiation 31.

The display device 4 according to the exemplary embodiment of the illuminated radar module 1 in FIG. 2 comprises a plurality of light-emitting elements 5, which are arranged in the form of a symbol on the main surface of the carrier 4. Light-emitting elements 5 that are arranged next to each other in a direction perpendicular to the polarization direction P of the first electromagnetic radiation 31 are electrically connected in series via a conductor track 6 and form a strand. The conductor track 6 runs perpendicular to the polarization direction P.

The light-emitting elements 5 are micro-LEDs, wherein each micro-LED has an edge length of at most 200 μm. In particular, each micro-LED comprises a width of 100 μm and a length of 150 μm. The width denotes a spatial extension of the micro-LED in a direction parallel to the polarization direction, while the length denotes a spatial extension of the micro-LED in a direction perpendicular to the polarization direction. A distance between adjacent micro-LEDs within a strand is between 100 μm and 200 μm, inclusive.

The conductor tracks 6 have a width B of between 1 μm and 400 μm, inclusive, preferably between 5 μm and 20 μm, inclusive. A distance A between parallel conductor tracks 6 is 200 μm. By use of micro-LEDs in connection with the arrangement of the conductor tracks 6 with a main extension direction perpendicular to the polarization direction P of the first electromagnetic radiation 31, the display element 4 advantageously has a high transparency for the first electromagnetic radiation 31.

In contrast to the exemplary embodiment of an illuminated radar module 1 described in connection with FIG. 2, the display device in FIG. 3 comprises conductor tracks 6 which run parallel to the polarization direction P of the first electromagnetic radiation in places. In particular, the conductor tracks 6 comprise rectilinear sections 61 which are arranged parallel to the polarization direction P of the first electromagnetic radiation.

Sections 61 of the conductor tracks 6, which do not run perpendicular to the polarization direction P, are arranged, in particular, outside the radiation region 33. Thus, the transmittance of the display device 4 is only slightly or not at all influenced by the sections 61 of the conductor tracks 6 that run parallel to the polarization direction P.

FIG. 4 shows a schematic cross-sectional view of an illuminated radar module 1 according to the exemplary embodiment described in connection with FIG. 1. In particular, the first electromagnetic radiation 31 generated by the emitter 2 during operation penetrates the display device 4 only within the radiation region 33. The second electromagnetic radiation 32 emitted by the display device 4 comprises the same emission direction R as the first electromagnetic radiation 31.

FIG. 5 shows a schematic circuit of light-emitting elements 5 of a display device 4 of an illuminated radar module 1 according to an exemplary embodiment. In this case, light-emitting elements 5 arranged in a direction perpendicular to the polarization direction P of the first electromagnetic radiation 31 are electrically connected in series via a conductor track 6. In each case, three parallel strands arranged next to each other are electrically connected in parallel. In particular, this makes it possible to reduce the number of channels required in a driver circuit to control the display device 4.

The sections 61 of the conductor tracks 6 running parallel to the polarization direction P have a comparatively small length L, so that the transmittance of the display device 4 for the first electromagnetic radiation 31 is only insignificantly reduced.

FIG. 6 shows a further arrangement of conductor tracks 6 in a display device 4 of an illuminated radar module 1 according to a further exemplary embodiment. Here, light-emitting elements 5 arranged next to one another in a direction perpendicular to the polarization direction P of the first electromagnetic radiation 31 are each divided into two sub-strands 52. Within a sub-strand 52, the light-emitting elements 5 are electrically connected in series via a section 61 of a conductor track 6. These sections 61 of the conductor tracks 6 run perpendicular to the polarization direction P.

The two sub-strands 52 are each electrically connected in parallel. For this purpose, the conductor tracks 6 comprise short sections 61 that run parallel to the polarization direction P. These sections 61 running parallel to the polarization direction P are, in particular, shorter than one tenth of the wavelength λ of the first electromagnetic radiation 31, so that the transmittance of the display device 4 is only insignificantly reduced by these sections 61.

In particular, by connecting the sub-strands 52 in parallel, the number of channels of a driver circuit required to control the light-emitting elements 5 during operation of the display device 4 can be reduced. For example, the maximum operating voltage of a channel of the driver circuit is too low to operate all light-emitting elements 5 of the two sub-strands 52 in series.

FIG. 7 shows conductor tracks 6 of a display device 4 of an illuminated radar module 1 according to a further exemplary embodiment. The conductor tracks 6 run perpendicular to the polarization direction P of the first electromagnetic radiation 31, with each conductor track 6 comprising three parallel segments 62 that are electrically connected to one another at regular distances. In other words, each conductor track 6 is grid-shaped.

Each segment 62 of the conductor track 6 comprises a cross-sectional area that is large enough to carry the operating current for the light-emitting elements 5 electrically connected thereto. The segments 62 of a conductor track 6 are thus redundant for the operation of the display device 4. A thickness of the conductor tracks 6 in a direction perpendicular to the main plane of extension of the display device 4 is at most 15 μm. In particular, the thickness of the conductor tracks 6 is so small that, for example, isolated interruptions in the segments 62 can occur during the manufacturing process of the conductor tracks 6. Due to the redundant segments 62, the functionality of the display device 4 can be advantageously maintained even if interruptions occur.

FIG. 8 shows conductor tracks 6 of a display device 4 of an illuminated radar module 1 according to a further exemplary embodiment. In contrast to the exemplary embodiment described in connection with FIG. 7, the three segments 62 of each conductor track 6 are electrically connected to one another at fewer points. In particular, the electrical connections 63 between the neighboring segments 62 are arranged offset to one another. Thus, the conductor tracks 6 advantageously comprise fewer connections 63 that are arranged parallel to the polarization direction P.

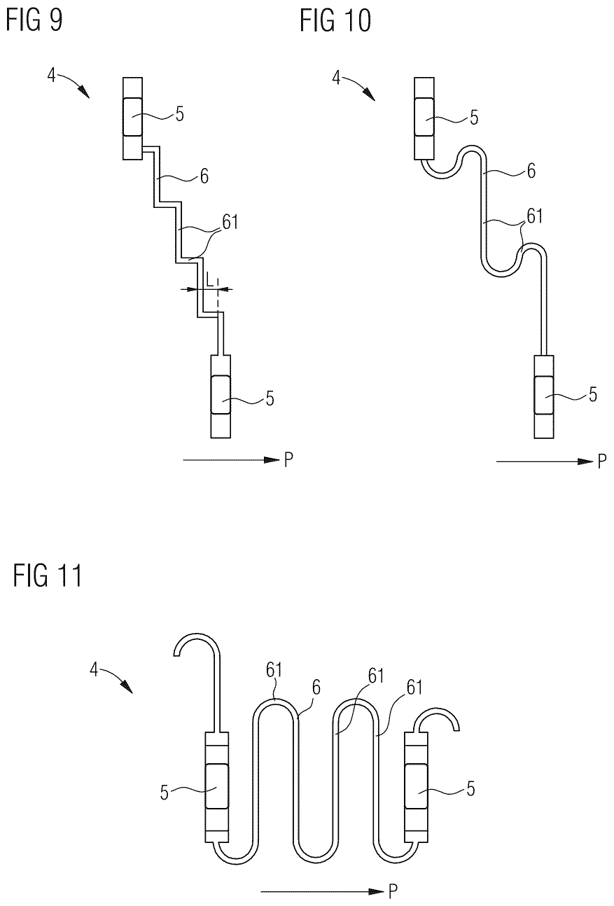

FIG. 9 shows an arrangement of conductor tracks 6 of a display device 4 of an illuminated radar module 1 according to a further exemplary embodiment. In particular, the configuration of a conductor track 6 is shown, which electrically connects two light-emitting elements 5 to each other that are arranged offset both perpendicular and parallel to the polarization direction P of the first electromagnetic radiation 31. The conductor track 6 comprises a plurality of sections 61 that run alternately parallel and perpendicular to the polarization direction P. The sections 61 running parallel to the polarization direction P have a length L which is at most one tenth of the wavelength λ of the first electromagnetic radiation 31.

FIG. 10 shows an arrangement of conductor tracks 6 of a display device 4 of an illuminated radar module 1 according to a further exemplary embodiment. In contrast to the exemplary embodiment described in connection with FIG. 9, instead of the sections 61 of the conductor tracks 6 running parallel to the polarization direction P, meander-shaped sections 61 are arranged between the sections 61 running perpendicular to the polarization direction P. In particular, the meander-shaped sections 61 comprise two semicircular subsections. As a result, the conductor track 6 advantageously comprises only a few sections that are arranged parallel to the polarization direction P.

FIG. 11 shows an arrangement of conductor tracks 6 of a display device 4 of an illuminated radar module 1 according to a further exemplary embodiment. Here, a conductor track 6 connects two light-emitting elements 5, which are arranged next to each other in a direction parallel to the polarization direction P. The conductor track 6 thus comprises a main extension direction parallel to the polarization direction P.

The conductor track 6 is meander-shaped and comprises several sections 61 that extend perpendicular to the polarization direction P and are arranged parallel to each other. Adjacent parallel sections 61 are connected to each other at end points via curved sections 61. As a result, the conductor track 6 advantageously comprises only a few areas that are arranged parallel to the polarization direction P.

FIG. 12 shows a wave-optical simulation of the transmittance T of a display device 4 as a function of a wavelength λ of the first electromagnetic radiation 31 of an illuminated radar module 1. The transmittance T of a display device 4 is shown, which comprises a plurality of rectilinear conductor tracks 6 running parallel to one another. The conductor tracks 6 each have a thickness of 2 μm. The dashed vertical lines mark two examples of wavelengths of the first electromagnetic radiation 31 of an emitter 2.

The first transmittance 81 corresponds to a display device 4 with a plurality of parallel conductor tracks 6 with a width B (see FIG. 2) of 8 μm at a distance A (see FIG. 2) of 200 μm, which run parallel to the polarization direction P of the first electromagnetic radiation 31.

The second transmittance 82 corresponds to a display device 4 with a plurality of parallel conductor tracks 6 with a width B (see FIG. 2) of 20 μm at a distance A (see FIG. 2) of 800 μm, which run parallel to the polarization direction P of the first electromagnetic radiation 31.

The third transmittance 83 corresponds to a display device 4 with a plurality of parallel conductor tracks 6 with a width B (see FIG. 2) of 20 μm at a distance A (see FIG. 2) of 2000 μm, which run parallel to the polarization direction P of the first electromagnetic radiation 31.

The fourth transmittance 84 corresponds to a display device 4 with a plurality of parallel conductor tracks 6 with a width B (see FIG. 2) of 20 μm at a distance A (see FIG. 2) of 6000 μm, which run parallel to the polarization direction P of the first electromagnetic radiation 31.

For wavelengths λ that are approximately larger than the distance A between the conductor tracks 6, the first to fourth transmittances 81, 82, 83, 84 decrease sharply. In order to achieve a high transmittance T with an arrangement of rectilinear conductor tracks parallel to the polarization direction P of the first electromagnetic radiation 31, a large distance A between the conductor tracks 6 is therefore advantageous, which is preferably larger than the wavelength λ of the first electromagnetic radiation 31.

The fifth transmittance 85 corresponds to a display device 4 with a plurality of parallel conductor tracks 6 with a width B (see FIG. 2) of 8 μm at any distance A (see FIG. 2) between 200 μm and 6000 μm, which run perpendicular to the polarization direction P of the first electromagnetic radiation 31. In this case, the transmittance T is approximately 100% and largely independent of the wavelength λ of the first electromagnetic radiation 31.

This patent application claims the priority of the German patent application DE 102022126446.7, the disclosure content of which is hereby incorporated by reference.

The invention is not limited to the description based on the exemplary embodiments. Rather, the invention includes any new feature as well as any combination of features, which includes in particular any combination of features in the patent claims, even if this feature or combination itself is not explicitly stated in the patent claims or exemplary embodiments.

### LIST OF REFERENCE SYMBOLS

1 illuminated radar module
2 emitter
31 first electromagnetic radiation
32 second electromagnetic radiation
33 radiation region
4 display device
41 carrier
5 light emitting element
51 edge length
52 sub-strand
6 conductor track
61 section
62 segment
63 connection
7 detector
81 first transmittance
82 second transmittance
83 third transmittance
84 fourth transmittance
85 fifth transmittance
A distance
B width
L length
P polarization direction
R emission direction
T transmittance
λ wavelength

1. An illuminated radar module comprising:
an emitter emitting a linearly polarized first electromagnetic radiation during operation,
a display device comprising a plurality of light-emitting elements and conductor tracks for electrically contacting the light-emitting elements, wherein
the display device is arranged downstream of the emitter in an emission direction of the first electromagnetic radiation,
in a radiation region of the first electromagnetic radiation the conductor tracks extend over at least 70% of their length transversely to the polarization direction of the first electromagnetic radiation,
the display device comprises a carrier which is at least partially transparent to the first electromagnetic radiation, wherein the light-emitting elements and the conductor tracks are arranged on the carrier, and
the plurality of light-emitting elements are arranged on the carrier in the form of a symbol.

2. The illuminated radar module comprising:
an emitter emitting a linearly polarized first electromagnetic radiation during operation,
a display device comprising a plurality of light-emitting elements and conductor tracks for electrically contacting the light-emitting elements, wherein
the display device is arranged downstream of the emitter in an emission direction of the first electromagnetic radiation,
in a radiation region of the first electromagnetic radiation a length of each conductor track projected onto the polarization direction of the first electromagnetic radiation is at most five times a wavelength of the first electromagnetic radiation,
the display device comprises a carrier which is at least partially transparent to the first electromagnetic radiation, wherein the light-emitting elements and the conductor tracks are arranged on the carrier, and
the plurality of light-emitting elements are arranged on the carrier in the form of a symbol.

3. The illuminated radar module according to claim 1, wherein
in the radiation region of the first electromagnetic radiation a length of each conductor track projected onto the polarization direction of the first electromagnetic radiation is at most five times a wavelength of the first electromagnetic radiation.

4. The illuminated radar module according to claim 2, wherein
in a radiation region of the first electromagnetic radiation the conductor tracks extend over at least 70% of their length transversely to the polarization direction of the first electromagnetic radiation.

5. The illuminated radar module according to claim 1, wherein
the first electromagnetic radiation comprises a wavelength in a range between 1 mm and 10 cm, inclusive.

6. The illuminated radar module according to claim 1, wherein
at least one light-emitting element emits a second electromagnetic radiation during operation, which comprises the same emission direction as the first electromagnetic radiation.

7. The illuminated radar module according to claim 1, wherein
at least one light-emitting element comprises a light-emitting semiconductor diode with an edge length of at most 1 mm.

8. The illuminated radar module according to claim 1, wherein
a width of the conductor tracks is at most 1 mm.

9. The illuminated radar module according to claim 1, wherein
a distance between sections of the conductor tracks extending perpendicular to the polarization direction of the first electromagnetic radiation in the radiation region of the first electromagnetic radiation is at least 100 μm.

10. The illuminated radar module according to claim 1, wherein
sections of the conductor tracks in the radiation region of the first electromagnetic radiation, which extend in a direction parallel to the polarization direction of the first electromagnetic radiation, have a length of at most one tenth of the wavelength of the first electromagnetic radiation.

11. The illuminated radar module according to claim 1, wherein
a distance between sections of the conductor tracks running parallel to the polarization direction of the first electromagnetic radiation in the radiation region of the first electromagnetic radiation is equal to or larger than half the wavelength of the first electromagnetic radiation.

12. The illuminated radar module according to claim 1, wherein
sections of the conductor tracks in the radiation region of the first electromagnetic radiation, which have a main extension direction parallel to the polarization direction of the first electromagnetic radiation, are meander-shaped.

13. The illuminated radar module according to claim 1, wherein
sections of the conductor tracks that run parallel to the polarization direction of the first electromagnetic radiation are arranged outside the radiation region of the first electromagnetic radiation.

14. The illuminated radar module according to claim 1, wherein
at least one conductor track comprises at least two parallel segments that are electrically connected to one another in places.

15. The illuminated radar module according to claim 1, wherein
a plurality of light-emitting elements is electrically connected in series via a conductor track extending perpendicular to the polarization direction of the first electromagnetic radiation.

16. The illuminated radar module according to claim 1, wherein
a plurality of light-emitting elements that are arranged next to one another in a direction perpendicular to the polarization direction of the first electromagnetic radiation are divided into two sub-strands that are electrically connected in parallel, wherein the light-emitting elements of each sub-strand are electrically connected in series.

17. The illuminated radar module according to claim 1,
further comprising a detector for the first electromagnetic radiation.

18-19. (canceled)
